(19) United States
(12) Patent Application Publication
(10) Pub. No.: US 2021/0182011 A1
(43) Pub. Date: Jun. 17, 2021

(54) LIGHTING APPARATUS

(71) Applicant: PANASONIC INTELLECTUAL PROPERTY MANAGEMENT CO., LTD., Osaka (JP)

(72) Inventors: Koji OSHIMA, Kanagawa (JP); Taiichiro OZAKI, Kanagawa (JP)

(73) Assignee: PANASONIC INTELLECTUAL PROPERTY MANAGEMENT CO., LTD., Osaka (JP)

(21) Appl. No.: 16/759,188

(22) PCT Filed: Oct. 18, 2018
(86) PCT No.: PCT/JP2018/038840

§ 371 Date: Apr. 24, 2020

(30) Foreign Application Priority Data
Oct. 27, 2017 (JP) 2017-207903

(51) Int. Cl. G06F 3/14; F21V 33/00; G09G 3/20; G06F 3/16

(52) U.S. Cl. CPC G06F 3/1446; F21V 33/0056; G09G 3/20; G09G 2360/04; G09G 2356/00; G09G 2370/16; G06F 3/16

(57) ABSTRACT

A lighting apparatus includes: a light source that emits light; an electronic panel that processes and passes therethrough the light emitted by the light source; and a controller that controls the electronic panel to display predetermined image data on the electronic panel. The controller receives predetermined image data, which is stored in an external storage device separate from the lighting apparatus, from the external storage device, and causes the electronic panel to display the received predetermined image data.

### TECHNICAL FIELD

The present disclosure relates to a lighting apparatus that emits light to a surrounding environment and to a lighting system provided with the lighting apparatus.

### BACKGROUND ART

Heretofore, for example, as disclosed in the following Patent Literature 1, there has been performed a development of a lighting apparatus including: a light source that emits light; and a display screen capable of processing the light emitted by the light source and displaying image data. In accordance with this lighting apparatus, both of a lighting function and an image display function can be exerted.

### CITATION LIST

### Patent Literature

Patent Literature 1: Japanese Unexamined Utility-Model Application Publication No. S61-68413

### SUMMARY OF INVENTION

### Technical Problem

The lighting apparatus including the conventional display screen switches a plurality of types of previously prescribed image data and causes the display screen to display the same. Therefore, the lighting apparatus cannot change the image data to be displayed on the display screen in accordance with a user's preference. Hence, the types of the image data to be displayed on the display screen of the lighting apparatus are limited.

The present disclosure has been made in consideration of such a problem as described above, which is inherent in the prior art. Then, it is an object of the present disclosure to provide a lighting apparatus capable of enriching variations of the image data to be displayed on the display screen and to provide a lighting system provided with the lighting apparatus.

### Solution to Problem

In order to solve the above-described problem, a lighting apparatus according to a first aspect of the present disclosure is a lighting apparatus including: a light source configured to emit light; an electronic panel configured to process and pass therethrough the light emitted by the light source; and a controller configured to control the electronic panel to display predetermined image data on the electronic panel, wherein the controller receives the predetermined image data, which is stored in an external storage device separate from the lighting apparatus, from the external storage device, and causes the electronic panel to display the received predetermined image data.

A lighting system according to a second aspect of the present disclosure is a lighting system including: a plurality of lighting apparatuses, each including a same configuration as a configuration of the lighting apparatus of the first aspect, wherein a plurality of the controllers control a plurality of the electronic panels to display the same predetermined image data individually on the plurality of electronic panels in synchronization with each other, or control the plurality of electronic panels to display the predetermined image data integrated as one as a whole.

A lighting system according to a third aspect of the present disclosure is a lighting system including: the lighting apparatus of the first aspect; and an external instrument including a display screen and a display controller configured to control the display screen, wherein the controller and the display controller control the electronic panel and the display screen, respectively to individually display the same predetermined image data on the electronic panel and the display screen in synchronization with each other, or control the electronic panel and the display screen to display the predetermined image data integrated as one as a whole on the electronic panel and the display screen.

### Advantageous Effects of Invention

In accordance with each of the lighting apparatus and lighting system of the present disclosure, the variations of the image data to be displayed on the display screen can be enriched.

### BRIEF DESCRIPTION OF DRAWINGS

FIG. 1 is a block diagram for explaining an entire configuration of a lighting system common to respective embodiments of the present disclosure.

FIG. 2 is a perspective view for explaining a lighting apparatus of Embodiment 1 of the present disclosure.

FIG. 3 is a diagram for explaining a use state of such lighting apparatuses of Embodiment 1 of the present disclosure.

FIG. 4 is a flowchart for explaining a control of such lighting apparatuses of Embodiment 1 of the present disclosure.

FIG. 5 is a perspective view for explaining a lighting apparatus of Embodiment 2 of the present disclosure.

FIG. 6 is a front view for explaining a lighting apparatus of Embodiment 3 of the present disclosure.

FIG. 7 is a schematic view for explaining a lighting apparatus of Embodiment 4 of the present disclosure.

FIG. 8 is a schematic view for explaining a lighting apparatus of Embodiment 5 of the present disclosure.

FIG. 9 is a functional block diagram of a controller of the lighting apparatus of Embodiment 5 of the present disclosure.

FIG. 10 is a flowchart for explaining a control of the lighting apparatus of Embodiment 5 of the present disclosure.

FIG. 11 is a schematic view for explaining a lighting apparatus of Embodiment 6 of the present disclosure.

FIG. 12 is a flowchart for explaining a control of the lighting apparatus of Embodiment 6 of the present disclosure.

FIG. 13 is a cross-sectional view for explaining a lighting apparatus of Embodiment 7 of the present disclosure.

FIG. 14 is a cross-sectional view for explaining a lighting apparatus of Embodiment 8 of the present disclosure.

FIG. 15 is a diagram for explaining a data table stored in a controller of a lighting apparatus of Embodiment 9 of the present disclosure.

FIG. 16 is a schematic configuration diagram for explaining the lighting apparatus of Embodiment 9 of the present disclosure.

FIG. 17 is a diagram for explaining a data table stored in a controller of a lighting apparatus of Embodiment 10 of the present disclosure.

FIG. 18 is a flowchart for explaining a control of the lighting apparatus of Embodiment 10 of the present disclosure.

FIG. 19 is a schematic view of a lighting system as one example of Embodiment 11 of the present disclosure. A left side of FIG. 19 illustrates one lighting apparatus among a plurality of lighting apparatuses which compose the lighting system, and a right side of FIG. 19 illustrates another lighting apparatus among the plurality of lighting apparatuses which compose the lighting system.

FIG. 20 is a schematic view of a lighting system as another example of Embodiment 11 of the present disclosure. A left side of FIG. 20 illustrates one lighting apparatus among the plurality of lighting apparatuses which compose the lighting system, and a right side of FIG. 20 illustrates another lighting apparatus among the plurality of lighting apparatuses which compose the lighting system.

FIG. 21 is a schematic view of a lighting system as another example of Embodiment 11 of the present disclosure. A left side of (a) of FIG. 21 illustrates one lighting apparatus among a plurality of lighting apparatuses which compose one lighting system in a certain situation, and a right side of (a) of FIG. 21 illustrates another lighting apparatus among the plurality of lighting apparatuses which compose the one lighting system in such a certain situation. A left side of (b) of FIG. 21 illustrates one lighting apparatus among the plurality of lighting apparatuses which compose the lighting system in another situation, and a right side of (b) of FIG. 21 illustrates another lighting apparatus among the plurality of lighting apparatuses which compose the lighting system in such another situation.

FIG. 22 is a schematic view of a lighting system as yet another example of Embodiment 11 of the present disclosure. A left side of FIG. 22 illustrates one lighting apparatus among the plurality of lighting apparatuses which compose the lighting system, and a right side of FIG. 22 illustrates another lighting apparatus among the plurality of lighting apparatuses which compose the lighting system.

FIG. 23 is a schematic view of a lighting system as an example of Embodiment 12 of the present disclosure. A left side of FIG. 23 illustrates a lighting apparatus that composes the lighting system, and a right side of FIG. 23 illustrates an external instrument that composes the lighting system.

FIG. 24 is a schematic view of a lighting system as another example of Embodiment 12 of the present disclosure. (a) of FIG. 24 illustrates a certain situation of a combination of the lighting apparatus and the external instrument, which compose the lighting system, and (b) of FIG. 24 illustrates another situation of the combination of the lighting apparatus and the external instrument, which compose the lighting system.

FIG. 25 is a schematic view of a lighting system as still another example of Embodiment 12 of the present disclosure. A left side of FIG. 25 illustrates a lighting apparatus that composes the lighting system, and right side of FIG. 25 illustrates an external instrument that composes the lighting system.

### DESCRIPTION OF EMBODIMENTS

A description will be given below of a lighting apparatus and a lighting system according to each of embodiments with reference to the drawings. In the following respective drawings, it is defined that, unless otherwise described, portions denoted by the same reference numerals exert mutually the same functions even if shapes thereof on the drawings are a little different from one another.

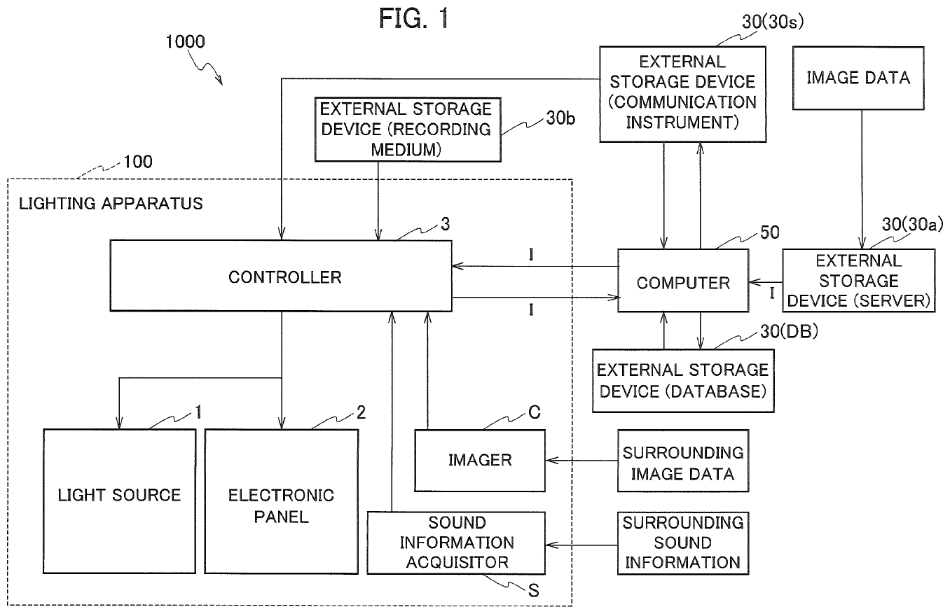

A description will be given below of an entire configuration of a lighting system 1000 of each of the embodiments with reference to FIG. 1.

As illustrated in FIG. 1, the lighting apparatus 100 includes a light source 1, an electronic panel 2, a controller 3, a sound information acquisitor S, and an imager C.

The light source 1 is capable of changing a light emitting mode, and moreover, can emit a light signal. The electronic panel 2 is, for example, a liquid crystal display capable of passing therethrough light emitted by the light source 1. The sound acquisitor S acquires sound information around the lighting apparatus 100, and transmits the sound information to the controller 3. The imager C acquires predetermined image data around the lighting apparatus 100, and transmits the predetermined image data to the controller 3.

Moreover, the predetermined image data is transmitted to the controller 3 via an external storage device 30 (server 30a), an electric communication information network I, and a computer 50. Furthermore, the predetermined image data is transmitted to the controller 3 from the external storage device 30 (recording medium 30b) capable of being integrated with the lighting apparatus 100. Moreover, the predetermined image data is directly transmitted to the controller 3 from the external storage device (communication instrument 30s). Further, the predetermined image data is transmitted to the controller 3 via the computer 50 and the electric communication information network I on the basis of an operation of the external storage device (communication instrument 30s). By communication with the external storage device 30 (database DB), the computer 50 reads out the predetermined image data from the external storage device 30 (database DB), and transmits the predetermined image data to the controller 3 of the lighting instrument 100.

When the recording medium 30b as the external storage device 30 is attached to the lighting apparatus 30b, the controller 3 can read and store information stored in the recording medium 30b.

The communication instrument 30s as the external storage device 30 is, for example, a portable terminal such as a smartphone. The communication instrument 30s is a personal computer or the like, which can transmit control information to the computer 50 or the controller 3 of the lighting apparatus 100 and can control the lighting apparatus 100. Moreover, the lighting apparatus 30 can emit a light signal from the light source 1 to the ambient environment, and particularly, to the communication instrument 30s.

Details of the lighting apparatus 100 used for the lighting system 1000 will be described in the following respective embodiments.

### Embodiment 1

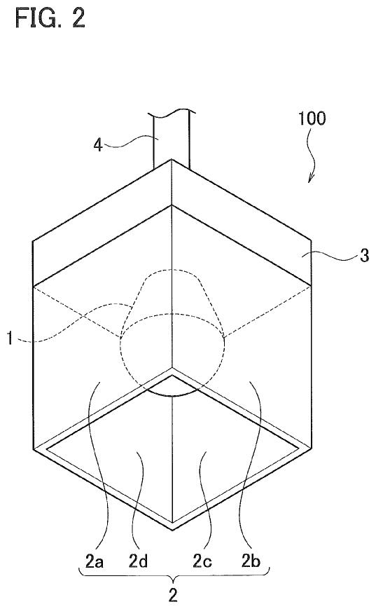

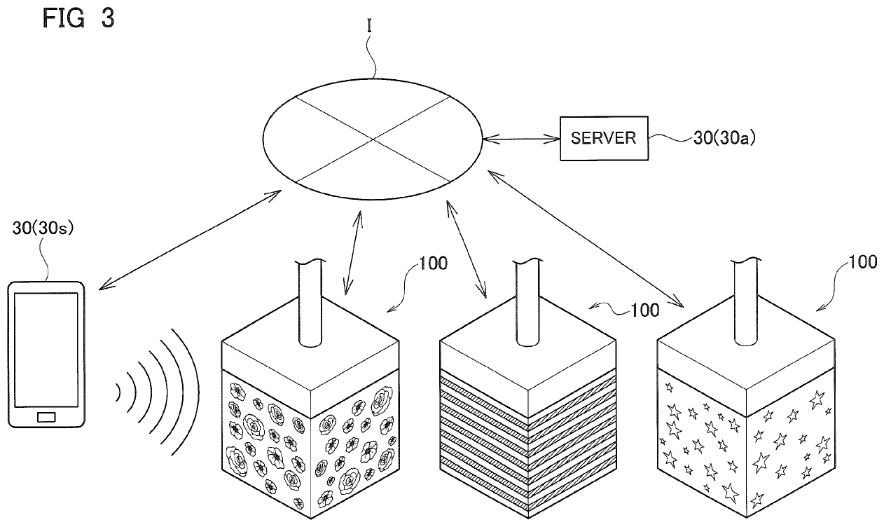

A description will be given below of a lighting apparatus 100 of Embodiment 1 with reference to FIG. 2 and FIG. 3.

As illustrated in FIG. 2, the lighting apparatus 100 of this embodiment includes: a light source 1 that emits light; an electronic panel 2 that processes and passes therethrough the light emitted by the light source 1; and a controller 3 that controls the electronic panel 2 to display predetermined image data on the electronic panel 2. That is, the lighting apparatus 100 of this embodiment functions as a display device that displays predetermined image data on the electronic panel 2. Moreover, when the controller 3 makes the electronic panel 2 completely transparent, the lighting apparatus 100 of this embodiment also functions as a normal lighting apparatus. Furthermore, when the controller 3 displays the predetermined image data in a translucent state on the electronic panel 2, the lighting apparatus 100 of this embodiment can show a state in which the light emitted by the light source 1 and the display of the electronic panel 2 are superimposed on each other to people around the lighting apparatus 100.

In FIG. 2, as an example of the lighting apparatus 100, there is illustrated an example in which the lighting apparatus 100 is suspended from a ceiling by a support bar 4 in a room; however, the lighting apparatus 100 may be one attached to an inner wall or one put on a floor. Moreover, the lighting apparatus 100 may be one embedded in the ceiling, the wall or the floor. Further, the lighting apparatus 100 may be one installed outdoors, such as on an outer wall and roof of a building, a road, a plaza, and a park.

The above-mentioned light source 1 is a light emitting diode (LED) lamp in an inside of which a light emitting diode is enclosed by a transparent cover. However, the light source 1 may be any one as long as it emits light. The above-mentioned electronic panel 2 may be any one as long as it can display the predetermined image data by passing light with a specific wavelength therethrough, and by restricting light with a specific wavelength from passing therethrough. Specifically, as an example of the above-mentioned electronic panel 2, a liquid crystal panel or an organic electro-luminescence (OEL) is mentioned. Moreover, as an example of the above-mentioned electronic panel 2, an organic light emitting diode (OLED), electronic paper or the like is mentioned.

In this embodiment, the electronic panel 2 is one formed by combining a plurality of, for example, four flat panels 2a, 2b, 2c and 2d with one another into a square cylindrical shape; however, may be a curved panel composed of an organic electro-luminescence or electronic paper. For example, the electronic panel 2 may be a single cylindrical curved panel, and if possible, may be a hemispherical curved panel. The electronic panel 2 may have any shape as long as it can process and pass therethrough the light emitted by the light source 1 and display the predetermined image data.

In this embodiment, a lower end of the cylindrical electronic panel 2 is opened, and such an internal light source 1 is made directly visible from a lower side of the lighting apparatus 100. However, the lighting apparatus 100 may be one in which the light source 1 is enclosed by a housing-like structure so that the light source 1 in the inside of the lighting apparatus 100 cannot be directly visible from an outside thereof

Moreover, the lighting apparatus 100 may include: such a planar electronic panel 2 that composes substantially the same plane as a surface of a wall, a floor or a ceiling; such a light source 1 provided on a back side of the electronic panel 2; and the controller 3 that controls such electronic panel 2 and light source 1 as described above.

As illustrated in FIG. 3, the controller 3 receives the predetermined image data, which is stored in the external storage device 30 separate from the lighting apparatus 100, from the external storage device 30, and causes such electronic panels 2 to display the received predetermined image data. With this, the predetermined image data stored in the external storage device 30 is changed or diversified, whereby variations of the predetermined image data to be displayed on the electronic panels 2 of such lighting apparatuses 100 can be enriched. The external storage device 30 may be any one as long as it can be separated from the lighting apparatuses 100, for example, may be provided outside the lighting apparatuses 100, or may be used integrally with such a lighting apparatus 100.

The controller 3 may be one that sequentially displays the predetermined image data, which is transmitted from the external storage device 30, on each of the electronic panels 2 without storing the same. Moreover, the controller 3 may be one that includes an internal storage that temporarily stores the predetermined image data transmitted from the external storage device 30, and causes the electronic panel 2 to display, at predetermined timing, the predetermined image data stored temporarily in the internal storage.

The above-mentioned predetermined image data may be any image data of scenery, a person, an animal, a vegetable, an article, an instrument, a building and the like. Moreover, the predetermined image data may include at least any one of a character, a diagram and a symbol. Furthermore, for example, the predetermined image data may be image data including predetermined information such as an advertisement. With this, the lighting apparatus 100 can transmit predetermined information to a person around the lighting apparatus 100.

The predetermined image data may be data to be switched at predetermined time intervals or continuously changed in accordance with a previously prescribed program, that is, may be switched image data or moving picture data. With this, the display of the lighting apparatus 100 can be automatically changed.

As illustrated in FIG. 3, in this embodiment, the external storage device 30 is a server 30a that is communicably connected to the controller 3 via the electric communication information network I such as the Internet and stores the predetermined image data. Therefore, the controller 3 causes the electronic panel 2 to display the predetermined image data transmitted from the server 30a. As a result, the lighting apparatus 100 can cause the electronic panel 2 to display the predetermined image data selected from among an enormous number of image data stored in the server 30a.

However, as illustrated in FIG. 3, the external storage device 30 may be a communication instrument 30s capable of executing a wireless communication, for example, a remote controller, or a cellular phone called a smartphone. In this case, the communication instrument 30s previously downloads image data from the server 30a. Thereafter, when necessary, the communication instrument 30s transmits the predetermined image data to the controller 3 of the lighting apparatus 100 directly or via the electric communication information network I.

The controller 3 receives the predetermined image data from the communication instrument 30s as the external storage device 30, and causes the electronic panel 2 to display the received predetermined image data. With this, for example, the lighting apparatus 100 can be caused to display the predetermined image data by using the already held communication instrument 30s such as a cellular phone.

Moreover, a user may transmit request information from the communication instrument 30s to the server 30a. In this case, the server 30a transmits the predetermined image data to the controller 3 of the lighting apparatus 100 via the electric communication information network I on the basis of the request information. In any of the cases described above, the user can select the predetermined image data to be displayed on the lighting apparatus 100 by just operating the communication instrument 30s.

As the communication instrument 30s, the computer 50 (see FIG. 1) such as a personal computer communicably connected to the electric communication information network I such as the Internet may be used in place of the remote controller or the smartphone. In this ease, the computer 50 such as the personal computer previously downloads the image data from the server 30a via the Internet I. Thereafter, when necessary, the computer 50 such as the personal computer transmits the predetermined image data to the controller 3 of the lighting apparatus 100 via the electric communication information network I. The computer 50 may be one in which an artificial intelligence is built.

In this embodiment, it is assumed that such predetermined image data determined by an administrator of the server 30a in accordance with a previously prescribed rule is automatically transmitted from the server 30a. However, the controller 3 may include the communication instrument 30a as an operation device operable by the user. The communication instrument 30a as an operation device is a portable terminal such as a tablet terminal and a smartphone. In this case, information for requesting for the predetermined image data selected by the user by the operation of the communication instrument 30a as an operation device is transmitted to the server 30a. Thus, the server 30a transmits the predetermined image data to the controller 3 on the basis of the information for requesting for the predetermined image data, the information having been received from the controller 3 of the lighting apparatus 100.

A procedure to be executed in this embodiment will be described with reference to a flowchart.

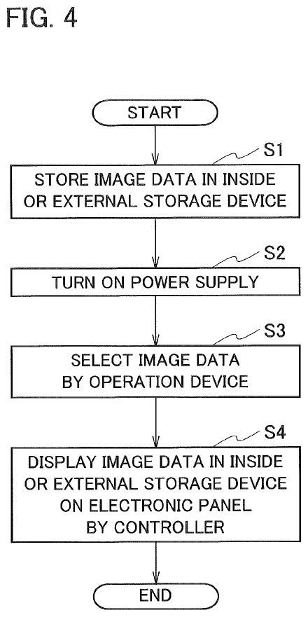

As illustrated in FIG. 4, in Step S1, the user of the lighting apparatus 100 stores the predetermined image data in an internal storage of the controller 3 or the external storage device 30. The internal storage is a storage of the controller 3. Next, in Step S2, the user turns on a power supply of the lighting apparatus 100. Thereafter, in Step S3, the user selects such single predetermined image data from among a large number of the predetermined image data stored in the database DB in the communication instrument 30a that is the external storage device 30 and functions as the operation device. In Step S4, the controller 3 causes the power supply 1 to emit light, and causes the electronic panel 2 to display the predetermined image data of the internal storage or the external storage device 30.

### Embodiment 2

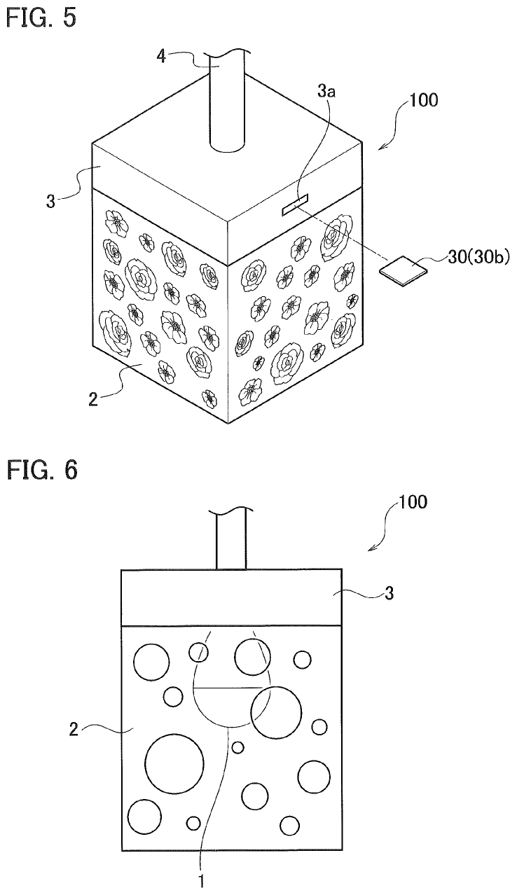

A description will be given below of a lighting apparatus 100 of Embodiment 2 with reference to FIG. 5.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

As illustrated in FIG. 5, in this embodiment, as the external storage device 30, a recording medium 30b that is recording predetermined image data readable by being attached to the controller 3 is used in place of the server 30a or communication instrument 30s of Embodiment 1. The recording medium 30b is inserted into an insertion slot 3a of the controller 3. Thus, the recording medium 30b is electrically connected to the controller 3, and becomes communicable with the controller 3. As a result, the controller 3 causes the electronic panel 2 to display the predetermined image data read out from the recording medium 30b attached to the controller 3.

In accordance with the lighting apparatus 100 of this embodiment, the electronic panel 2 of the lighting apparatus 100 can be caused to display the predetermined image data by only a user's simple manual operation of attaching the recording medium 30b to the controller 3. In the case of this embodiment, the predetermined image data stored in the recording medium 30b is changed, or alternatively, some recording media 30b in which stored predetermined mage data are different from one another are used. Thus, the variations of the predetermined image data caused to be displayed by the lighting apparatus 100 can be enriched.

The recording medium 30b may be any one as long as it has a mode readable by the controller 3 and stores the predetermined image data. The recording medium 30b includes a memory stick, a memory chip, a memory card, an optical disc, a magnetic disk and the like. Moreover, it is preferable that the recording medium 30b be one that records the predetermined image data in a mode rewritable by an already widespread electronic device, for example, a personal computer or a smartphone in order to facilitate the change of the predetermined image data.

### Embodiment 3

A description will be given below of a lighting apparatus 100 of Embodiment 3 with reference to FIG. 6.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

A light source 1 illustrated in FIG. 6 is a light emitting diode (LED) capable of executing at least one of dimming and toning. However, the light source I may be any one as long as it is capable of executing at least one of the dimming and the toning. If this light source 1 is used, then the controller 3 can execute at least one of dimming and toning of the light emitted from the light source 1 while controlling the electronic panel 2.

In accordance with the lighting apparatus 100 of this embodiment as described above, the variations of the predetermined image data to be displayed on the electronic panel 2 can be further enriched by combining the control of the electronic panel 2 and the control of the light source 1 with each other. Moreover, for example, by combining the light of the light source 1 and image data of such a translucent electronic panel 2 with each other, variations of an integrated rendering by the light source 1 and the electronic panel 2, which is as illustrated in FIG. 6 and is different from conventional ones, can be enriched.

The configuration of the lighting apparatus 100 of this embodiment may be combined with the configuration of the lighting apparatus 100 of Embodiment 1 or 2.

### Embodiment 4

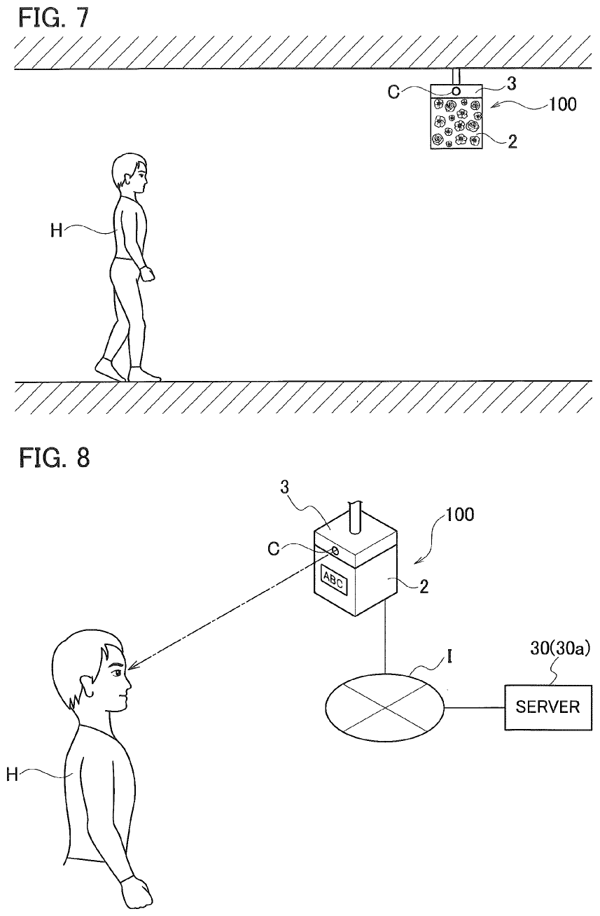

A description will be given below of a lighting apparatus 100 of Embodiment 4 with reference to FIG. 7.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

As illustrated in FIG. 7, in addition to an internal light source 1 (not shown) and an electronic panel 2 that displays predetermined image data, the lighting apparatus 100 of this embodiment includes an imager C that acquires image data around the lighting apparatus 100. The controller 3 controls the electronic panel 2 to display the predetermined image data on the electronic panel 2 in response to the image data around the lighting apparatus 100, which is acquired by the imager C. Therefore, the controller 3 can cause the electronic panel 2 to display the predetermined image data corresponding to a situation around the lighting apparatus 100.

In accordance with the lighting apparatus 100 of this embodiment, for example, when a person H approaches a position of a certain distance from the lighting apparatus 100, the light source 1 can be turned on, and the electronic panel 2 can be caused to change the predetermined image data. Moreover, for example, when the person H receded from the position of a certain distance from the lighting apparatus 100, the light source 1 can be turned off, and the electronic panel 2 can be caused to change the predetermined image data.

Moreover, for example, when the person H included in the image data around the lighting apparatus 100, which is acquired by the imager C, remains stationary, the controller 3 may cause the electronic panel 2 to display still image data as the predetermined image data. In this case, if the person H included in the image data of the lighting apparatus 100, which is acquired by the imager C, acts without moving, the controller 3 may cause the electronic panel 2 to display moving picture data that changes in time series as the predetermined image data.

Furthermore, for example, when the person H included in the image data around the lighting apparatus 100, which is acquired by the imager C, moves, the controller 3 may cause the electronic panel 2 to display moving picture data in which an object and a person move as the predetermined image data. Thus, there can be performed a rendering that interests the person H present around the lighting apparatus 100.

As a modified example of the lighting apparatus 100 of this embodiment, the controller 3 may transmit the image data around the lighting apparatus 100, which is imaged by the imager C, to the server 30a via the Internet I. In this case, an artificial intelligence may be built in the server 30a. The artificial intelligence of the server 30a selects predetermined image data suitable for the image data around the lighting apparatus 100, which is imaged by the imager C, and transmits the selected predetermined image data to the controller 3. Thus, the controller 3 receives the predetermined image data selected by the artificial intelligence of the server 30a on the basis of the image data around the lighting apparatus 100, and causes the electronic panel 2 to display the received predetermined image data. Thus also, the controller 3 can cause the electronic panel 2 to display the predetermined image data corresponding to a situation around the lighting apparatus 100.

The configuration of the lighting apparatus 100 of this embodiment may be combined with the configuration of the lighting apparatus 100 of any of Embodiments 1 to 3.

### Embodiment 5

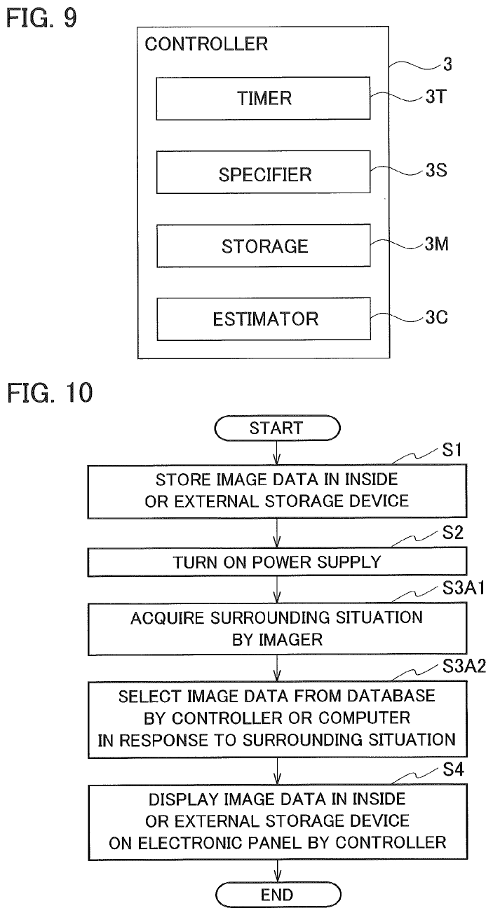

A description will be given below of a lighting apparatus 100 of Embodiment 5 with reference to FIG. 8 and FIG. 9.

A lighting apparatus 100 of this embodiment is substantially the same as the lighting apparatus 100 of Embodiment 4, and accordingly, a description of the same portions thereof will not be repeated. The lighting apparatus 100 of this embodiment is different from the lighting apparatus 100 of Embodiment 4 in terms of items to be described below.

As illustrated in FIG. 8, like the lighting apparatus 100 of Embodiment 4, the lighting apparatus 100 of this embodiment also includes the imager C that acquires the image data around the lighting apparatus 100. The controller 3 controls the electronic panel 2 to display the predetermined image data on the electronic panel 2 in response to the image data around the lighting apparatus 100, which is acquired by the imager C.

In FIG. 8, the single imager C is illustrated for the sake of convenience; however, a plurality of the imagers C may be provided in the lighting apparatus 100. Moreover, it is preferable that the plurality of imagers C be arranged so as to be capable of acquiring the image data around the lighting apparatus 100 over 360 degrees as all orientations in a horizontal plane. However, the single imager C may be provided in the lighting apparatus 100 so as to be rotatable about a virtual axis that extends along a vertical direction. In this case, the image data around the lighting apparatus 100 over 360 degrees as all orientations may be acquired in time series by the rotation of the single imager C about the virtual axis.

As illustrated in FIG. 9, a controller 3 of the lighting apparatus 100 of this embodiment includes a timer 3T that counts a time. Moreover, the controller 3 includes a specifier 3S that specifies an object or a display, which is present on an extension of a line of sight of the person H present around the lighting apparatus 100, on the basis of the image data around the lighting apparatus 100, which is acquired by the imager C.

Furthermore, the controller 3 of this embodiment includes a storage 3M that stores a value of the timer 3T when the image data is acquired and data of the object or the display, which is specified by the specifier 3S and is present on the extension of the line of sight of the person H, in association with each other. Moreover, the controller 3 includes an estimator 3C that estimates a preference of the person H present around the lighting apparatus 100 by using the value of the timer 3T and the data of the object or the display, which is present on the extension of the line of sight of the person II, the value and the data being stored in the storage 3M.

In this embodiment, the controller 3 sequentially switches the display of the electronic panel 2, which is directed in a direction in which the person H is present, in accordance with a previously prescribed procedure. Thereafter, the controller 3 performs image processing for image data of eyes of the person H, which is included in the image data acquired by the imager C. Thus, the controller 3 determines predetermined image data, which is viewed by the person H for a longest time, from among a plurality of types of the predetermined image data displayed on the electronic panel 2 on the basis of a counting time of the timer 3T for each predetermined image data stored in the storage 3M. Note that the data of the object or the display, which is present on the extension of the line of sight of the person H is the predetermined image data displayed on the electronic panel 2. Note that the person H is assumed to be a person present nearest the lighting apparatus 100.

Thereafter, the estimator 3C estimates that such predetermined image data in which the person H′s viewing time counted by the timer 3T is longest is predetermined image data in which the person H is interested most. Thus, on the basis of the estimation of the estimator 3C, the controller 3 lengthens a time of causing the electronic panel 2 to display the predetermined image data. As a result, from among the plurality of types of the predetermined image data, the lighting apparatus 100 can provide the person H around the lighting apparatus 100 with information, in which the person H is estimated to be interested most, for a longer time.

However, regarding the estimation of the preference of the person H, the preference may be determined on the basis of a size of pupils of the person H, or the like as well as the length of the time during which the person H views the object or the display. For example, the preference of the person H may be estimated by considering that the person H increases the pupils for the one in which the person H is interested more.

Moreover, in a situation in which the person H turns his/her back to the lighting apparatus 100 and the eyes of the person H cannot be imaged, the estimator 3C may estimate the preference of the person H from image data of a portion other than the person H in the image data acquired by the imager C. For example, when cosmetics are included in the image data imaged by the imager C, the estimator 3C may consider that the line of sight of the person H is directed to the cosmetics, and the controller 3 may cause the electronic panel 2 to display image data of the cosmetics. Thus, it becomes possible to provide the information capable of attracting interest from the person H present around the lighting apparatus 100. Note that, when the person H turns his/her back to the lighting apparatus 100, the estimator 3C estimates a direction of the view of the person H on the basis of the back view of the person H. In order to increase estimation accuracy of the estimator 3C, it is preferable that the direction of the line of sight be confirmed by experiment for each state of the back view of the person H.

In accordance with the lighting apparatus 100 of this embodiment described above, the controller 3 selects, as the predetermined image data, information suitable for the preference of the person H present around the lighting apparatus 100, the preference being estimated by the estimator 3C, and controls the electronic panel 2 to display the selected predetermined image data on the electronic panel 2. Therefore, it becomes possible to cause the electronic panel 2 to display information useful for the person H present around the lighting apparatus 100.

As a modified example of the lighting apparatus 100 of this embodiment, the controller 3 may transmit the image data around the lighting apparatus 100, which is imaged by the imager C, to the server 30a as the external storage device 30. In this case, an artificial intelligence is built in the server 30a. Thus, the artificial intelligence of the server 30a estimates the preference of the person H on the basis of the image data around the lighting apparatus 100, which is imaged by the imager C. That is, the server 30a exerts a similar function to that of the above-described estimator 3C. Hence, the server 30a selects the predetermined image data corresponding to the preference of the person H, and transmits the selected predetermined image data to the controller 3. Thus, the controller 3 receives, from the server 30a, the predetermined image data selected by the artificial intelligence of the server 30a on the basis of the image data around the lighting apparatus 100, and causes the electronic panel 2 to display the received predetermined image data. Thus also, the electronic panel 2 can be caused to display information useful for the person H present around the lighting apparatus 100.

A procedure to be executed in this embodiment will be described with reference to a flowchart.

As illustrated in FIG. 10, in Step S1, the user stores the predetermined image data in an internal storage of the controller 3 or the external storage device 30. The internal storage is a storage of the controller 3. Next, in Step S2, the user turns on a power supply of the lighting apparatus 100. Thereafter, in Step S3A1, the imager C acquires image information of the situation around the imager C. In Step S3A2, in response to such a surrounding situation, the controller 3 or the computer 50 selects single predetermined image data from among a large number of the predetermined image data stored in a database DB (see FIG. 1). In Step S4, the controller 3 displays, on the electronic panel 2, the selected predetermined image data of the internal storage or the external storage device 30.

The configuration of the lighting apparatus 100 of this embodiment may be combined with the configuration of the lighting apparatus 100 of any of Embodiments 1 to 4.

### Embodiment 6

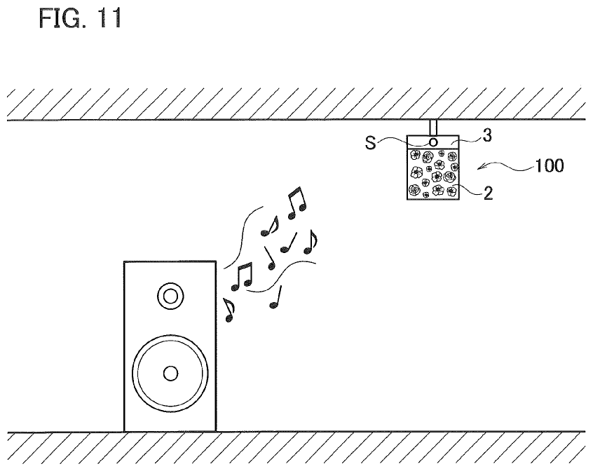

A description will be given below of a lighting apparatus 100 of Embodiment 6 with reference to FIG. 11.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

As illustrated in FIG. 11, the lighting apparatus 100 include a sound information acquisitor S that acquires sound information generated around the lighting apparatus 100. As an example of the sound information acquisitor S, a recorder attached with a microphone, or the like is mentioned. The controller 3 controls the electronic panel 2 to display predetermined image data on the electronic panel 2 in response to the sound information acquired by the sound information acquisitor S. In accordance with the lighting apparatus 100 of this embodiment, the predetermined image data corresponding to a situation of the sound information generated around the lighting apparatus 100 can be displayed.

For example, the predetermined image data to be displayed on the electronic panel 2 of the lighting apparatus 100 is changed to a rhythm of music playing in a dance hall or to a pitch of a sound thereof, whereby a rendering that has not been achieved heretofore can be achieved. Moreover, when a voice of a person present around the lighting apparatus 100 is louder than a certain level, such a warning display as “be quiet!” can be output. Moreover, for example, the lighting apparatus 100 may display a current time when the person present around the lighting apparatus 100 says “timepiece”, and may display a weather forecast when the person says “weather”. That is, the controller 3 may cause the electronic panel 2 to display the predetermined image data corresponding to the voice of the person H.

As a modified example of the lighting apparatus 100 of this embodiment, the controller 3 may transmit the sound information, which is acquired by the sound information acquisitor S, to the external storage device 30 such as the server 30a. In this case, the server 30a as the external storage device 30 may build an artificial intelligence therein. In this case, the artificial intelligence of the server 30a selects predetermined image data suitable for the sound information around the lighting apparatus 100, which is acquired by the sound information acquisitor S, and transmits the selected predetermined image data to the controller 3. Thus, the controller 3 receives, from the server 30a, the predetermined image data selected by the artificial intelligence of the server 30a on the basis of the sound information, and causes the electronic panel 2 to display the received predetermined image data. Thus also, the controller 3 can cause the electronic panel 2 to display the predetermined image data corresponding to the situation of the sound generated around the lighting apparatus 100.

A procedure to be executed in this embodiment will be described with reference to a flowchart.

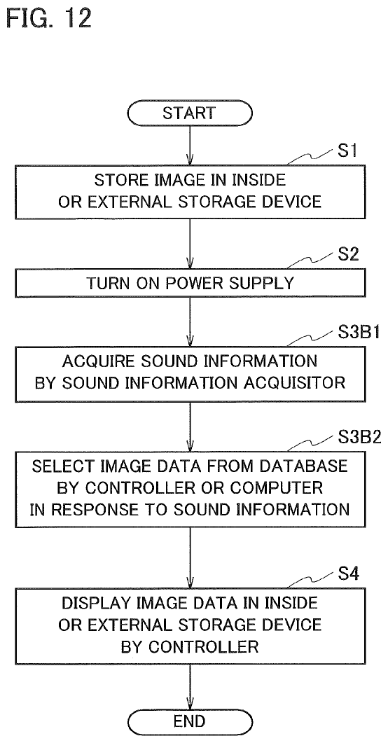

As illustrated in FIG. 12, in Step S1, the user stores the predetermined image data in an internal storage of the controller 3 or the external storage device 30. Next, in Step S2, the user turns on a power supply of the lighting apparatus 100. Thereafter, in Step S3B1, the sound information acquisitor S acquires the sound information of the situation around the sound information acquisitor S. In Step S3B2, in response to the sound information, the controller 3 or the computer 50 selects single predetermined image data from among a large number of the predetermined image data stored in a database DB (see FIG. 1). In Step S4, the controller 3 displays, on the electronic panel 2, the predetermined image data of the internal storage or the external storage device 30.

The configuration of the lighting apparatus 100 of this embodiment may be combined with the configuration of the lighting apparatus 100 of any of Embodiments 1 to 5.

### Embodiment 7

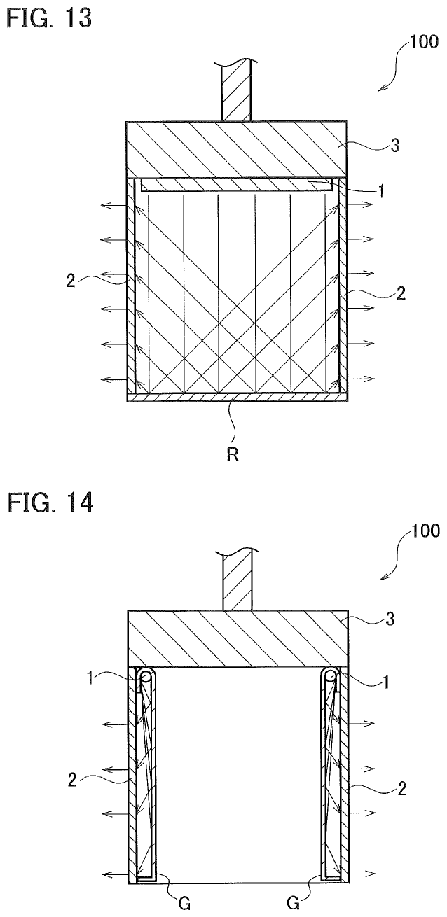

A description will be given below of a lighting apparatus 100 of Embodiment 7 with reference to FIG. 13.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

As illustrated in FIG. 13, the lighting apparatus 100 of this embodiment includes a reflector R that reflects light emitted by a light source 1. Moreover, the light source 1 of the lighting apparatus 100 of this embodiment is not a point light emitter that emits light from only one point, but a surface light emitter that emits light from an entire surface. The reflector R is a flat plate provided at a position facing the light source 1 composed of the surface light emitter.

In this embodiment, the light emitted from the light source 1 is reflected by the reflector R. Hence, the light emitted by the light source 1 and light reflected by the reflector R pass through the electronic panel 2. In accordance with the lighting apparatus 100 of this embodiment, it becomes unnecessary to provide the light source 1 on the hack side of the electronic panel 2, and accordingly, the shape of the lighting apparatus 100 can be changed variously by using the reflector R. As a result, variations of a design of the lighting apparatus 100 can be enriched.

The configuration of the lighting apparatus 100 of this embodiment may be combined with the configuration of the lighting apparatus 100 of any of Embodiments 2 to 6.

### Embodiment 8

A description will be given below of a lighting apparatus 100 of Embodiment 8 with reference to FIG. 14.

The lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

As illustrated in FIG. 14, the lighting apparatus 100 of this embodiment includes a light-guiding member G that reflects light emitted by a light source 1 and guides the light. The light guided by the reflection by the light-guiding member G passes through an electronic panel 2. Also, with this configuration, the shape of the light-guiding member G is differentiated, whereby the variations of the design of the lighting apparatus 100 can be enriched.

The configuration of the lighting apparatus 100 of this embodiment may be combined with the configuration of the lighting apparatus 100 of any of Embodiments 2 to 6.

### Embodiment 9

A lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

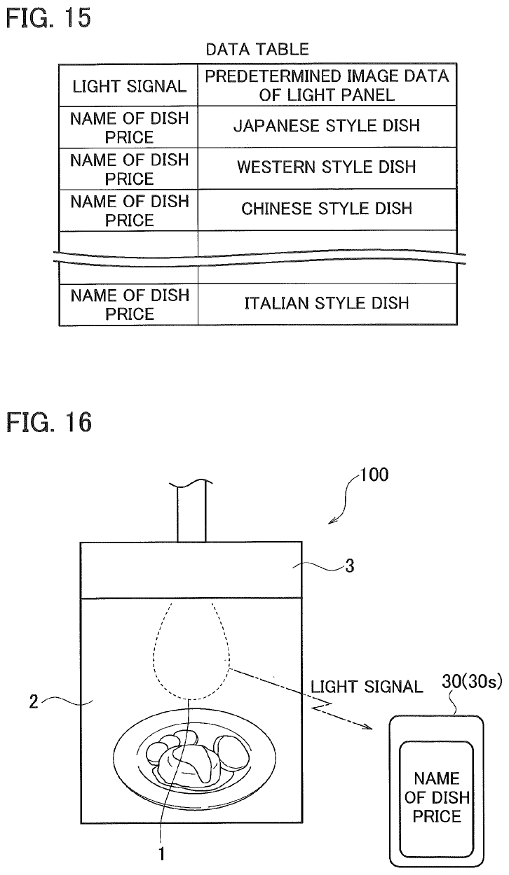

A description will be given below of the lighting apparatus 100 of Embodiment 9 with reference to FIG. 15 and FIG. 16.

As illustrated in FIG. 15, a database DB as the external storage device 30 includes a data table DT. However, the data table DT may be provided in any external storage device 30 (server 30a, recording medium 30b, database DB or the like) as long as information stored in the data table DT can be transmitted to the controller 3 of the lighting apparatus 100. The computer 50 transmits, to the controller 3, the data table DT stored in the external instrument 30 (server 30a, recording medium 30b, database DB or the like). Thus, the controller 3 controls the display panel 2 and the light source 1 by using data stored in the data table DT.

Specifically, the lighting apparatus 100 of this embodiment is used, for example, in a restaurant. In this case, for example, the data table DT stored in the database DB stores a light signal emitted by the light source 1 and predetermined image data of the display panel 2 in a one-to-one association relationship. The computer 50 reads out the data table DT from the database DB, and transmits the data table DT to the controller 3 of the lighting apparatus 100. Thus, the controller 3 causes the display panel 2 of the lighting apparatus 100 to display the predetermined image data of the light emitting panel 2, which is stored in the data table DT, and causes the light source 1 to transmit a light emitting signal stored in the data table DT.

When the predetermined image data to be displayed on the display panel 2 is sample image data of “Japanese style dish”, information specified by a light signal associated therewith and emitted by the light source 1 is “name of dish” and “price” of “Japanese style dish”. When the predetermined image data to be displayed on the display panel 2 is sample image data of “Western style dish”, information specified by a light signal associated therewith and emitted by the light source 1 is “name of dish” and “price” of “Western style dish”. When the predetermined image data to be displayed on the display panel 2 is sample image data of “Chinese style dish”, information specified by a light signal associated therewith and emitted by the light source 1 is “name of dish” and “price” of “Chinese style dish”. When the predetermined image data to be displayed on the display panel 2 is sample image data of “Italian style dish”, information specified by a light signal associated therewith and emitted by the light source 1 is “name of dish” and “price” of “Italian style dish”.

As illustrated in FIG. 16, the controller 3 causes the display panel 2 to display any one piece of specific image data among a certain number of the predetermined image data for the light emitting panel 2, for example, the image data of “Western style dish”. At this time, the controller 3 causes the light source 1 to transmit a specific light signal corresponding to the specific image data selected from among a plurality of light signals, that is, “name of dish” and “price” of “Wester style dish”.

The communication instrument 30s (see FIG. 1) reads the light signal, which is transmitted from the light source 1, by a light receiver usually used as a camera, and causes a display screen thereof to display the information specified by the light signal, that is, “name of dish” and “price” of “Wester style dish”. Therefore, dedicated application software for causing the display screen of the communication instrument 30s to display the information specified by the light signal received by the light receiver is downloaded to the communication instrument 30s from a specific site on the Internet 1, and is stored therein.

In accordance with the lighting apparatus 100 of this embodiment, the smartphone or the like, which serves as the communication instrument 30s (see FIG. 1) that has received the light signal, can be caused to display “name of dish” and “price” of “Wester style dish”, which are related to the image data of “Western style dish” displayed on the display panel 2. Hence, the user of the smartphone as the communication instrument 30a can easily grasp “name of dish” and “price” of “Wester style dish”, which are displayed on the display panel 2.

Note that, though the light signal is visible light, the user does not recognize the light signal by naked eyes since the light signal blinks at a high speed.

The configuration of the lighting apparatus 100 of this embodiment may be combined with the configuration of the lighting apparatus 100 of any of Embodiments 1 to 8.

### Embodiment 10

A lighting apparatus 100 of this embodiment is substantially the same as the lighting apparatus 100 of Embodiment 1, and accordingly, a description of the same portions thereof will not be repeated. The lighting apparatus 100 of this embodiment is different from the lighting apparatus 100 of Embodiment 1 in terms of items to be described below.

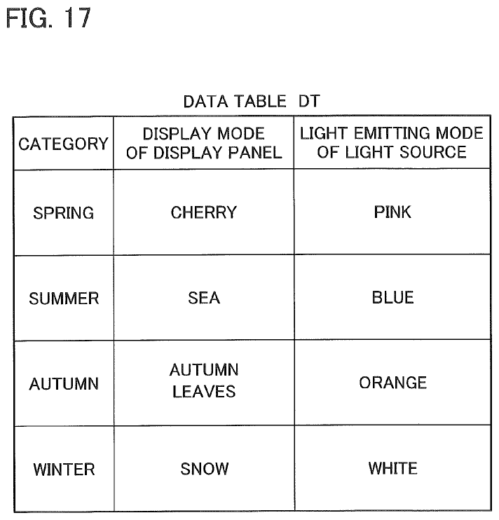

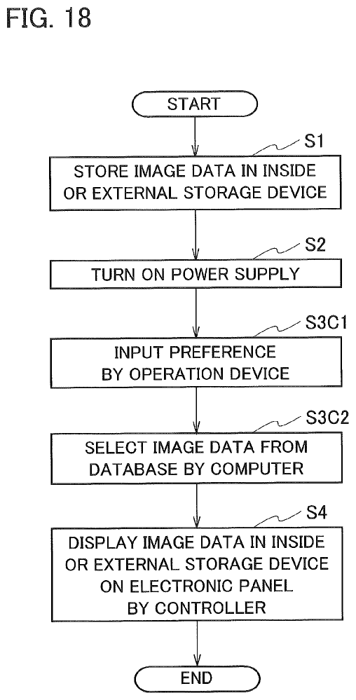

A description will be given below of the lighting apparatus 100 of Embodiment 10 with reference to FIG. 17 and FIG. 18.

As illustrated in FIG. 17, the database DB as the external storage device 30 includes a data table DT that stores the predetermined image data to be displayed on the display panel 2 and a light emitting mode of the light emitted by the light source 1 in association with each other for each of a plurality of types of categories. The data table DT provided in the database DB may be provided in any external storage device 30 (server 30b, recording medium 30b, database DB or the like).

The lighting apparatus 100 of this embodiment is used, for example, in a shop of a fashion house. In this case, the data table DT stores a category “spring”, predetermined image data “cherry” of the display panel 2, and a light emitting mode “pink” of the light source 1 in association with one another. The data table DT stores a category “summer”, predetermined image data “sea” of the display panel 2, and a light emitting mode “blue” of the light source 1 in association with one another. The data table DT stores a category “autumn”, predetermined image data “autumn leaves” of the display panel 2, and a light emitting mode “orange” of the light source 1 in association with one another. The data table DT stores a category “winter”, predetermined image data “snow” of the display panel 2, and a light emitting mode “white” of the light source 1 in association with one another.

Any one specific category among the plurality of types of categories “spring”, “summer”, “autumn” and “winter” is sometimes specified by the external communication instrument 3s. For example, in some cases, a smartphone as the communication instrument 30s is operated, and for example, the category “spring” is selected.

In this case, the lighting apparatus 100 receives the predetermined image data “cherry” of the display panel 2, which belongs to the category “spring”, and data of the light emitting mode “pink” of the light source 1 from the database DB via the computer 50 and the communication instrument 30s. Thus, the controller 3 causes the display panel 2 to display the predetermined image data “cherry” that belongs to the specific category “spring”. At this time, the controller 3 causes the light source 1 to emit light in the light emitting mode “pink” that belongs to the specific category “spring”.

In accordance with the lighting apparatus 100 of this embodiment described above, by just designating the category by the communication instrument 3s, a rendering in which the predetermined image data of the display panel 2 and the light emitting mode of the light source 1 are associated with each other can be executed. As a result, for example, by just designating a style, an atmosphere of the shop of the fashion house can be changed to an atmosphere suitable for the style.

A procedure to be executed in this embodiment will be described with reference to a flowchart.

As illustrated in FIG. 18, in Step S1, the user stores the predetermined image data in an internal storage of the controller 3 or the external storage device 30. Next, in Step S2, the user turns on a power supply of the lighting apparatus 100. Thereafter, in Step S3C1, the style, and specifically, the category is input to the communication instrument 30a as an operation device. In Step S3C2, the computer 50 selects the predetermined image data. In Step S4, the controller 3 displays, on the electronic panel 2, the predetermined image data that belongs to the predetermined category in the internal storage or the external storage device 30. At this time, the controller 3 causes the light source 1 to emit light in the light emitting mode that belongs to the category associated with the predetermined image data.

The configuration of the lighting apparatus 100 of this embodiment may be combined with the configuration of the lighting apparatus 100 of any of Embodiments 1 to 9.

### Embodiment 11

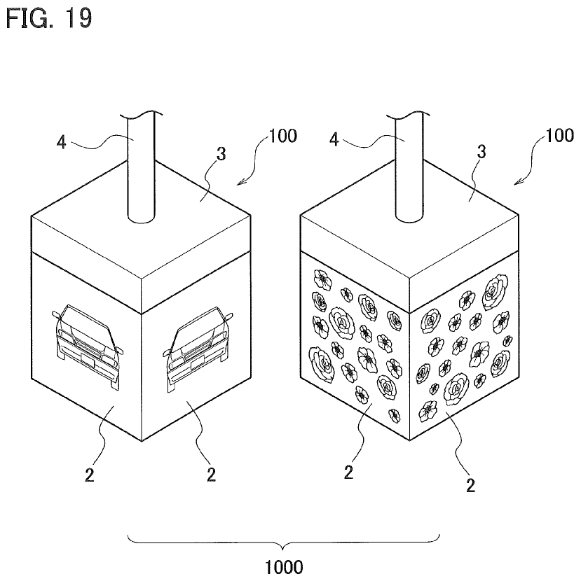

A description will be given below of a lighting system of Embodiment 11 with reference to FIG. 19 to FIG. 21.

A lighting apparatus 100 for use in the lighting system 1000 of this embodiment is the same as the lighting apparatuses 100 of Embodiments 1 to 10, and accordingly, a description of the same portions thereof will not be repeated. Characteristic configurations of the lighting system 1000 of this embodiment will be mainly described.

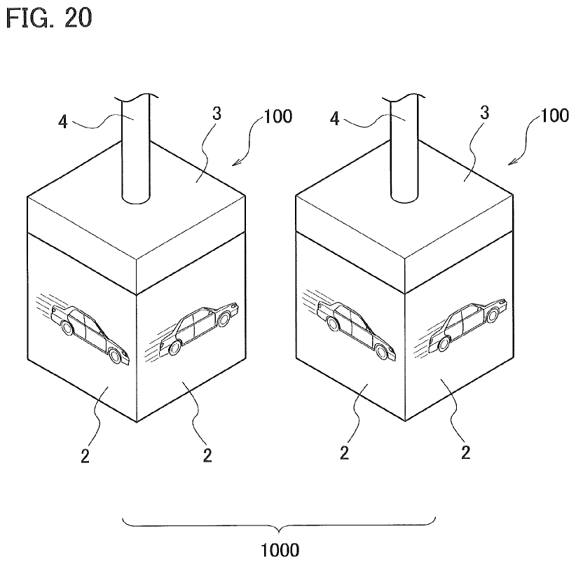

The lighting system 1000 of this embodiment includes a plurality of the lighting apparatuses 100. Usually, as illustrated in FIG. 19, each of the plurality of lighting apparatuses 100 displays predetermined image data different from other. However, at certain timing, as illustrated in FIG. 20, a plurality of controllers 3 control a plurality of electronic panels 2 to display the same predetermined image data individually on the plurality of electronic panels 2 in synchronization with each other.

That is, when the controller 3 of a certain lighting apparatus 100 among the plurality of lighting apparatuses 100 executes a certain program, that certain lighting apparatus 100 transmits a predetermined signal, and another lighting apparatus 100 that has received the predetermined signal executes the certain program. Thus, the plurality of lighting apparatuses 100 display the same predetermined image data at substantially the same time. However, a method of such a control may be any as long as the plurality of controllers 3 are synchronized with each other and control the plurality of electronic panels 2 to display the same predetermined image data individually on the plurality of electronic panels 2. For example, a signal to request transmission of the predetermined image data may be transmitted from the communication instrument 30s illustrated in FIG. 3 to the server 30a illustrated therein, and the same predetermined image data may be transmitted from the server 30a to the controllers 3 in synchronization with each other. Thus, the controllers 3 may be synchronized with each other and control the electronic panels 2 to display the same predetermined image data in synchronization with each other.

Moreover, the plurality of controllers 3 of the plurality of lighting apparatuses 100 may control the plurality of electronic panels 2 to display predetermined image data integrated as one as a whole on the electronic panels 2. With this, a great impact can be made on a person who views the predetermined image data around the plurality of lighting apparatuses 100.

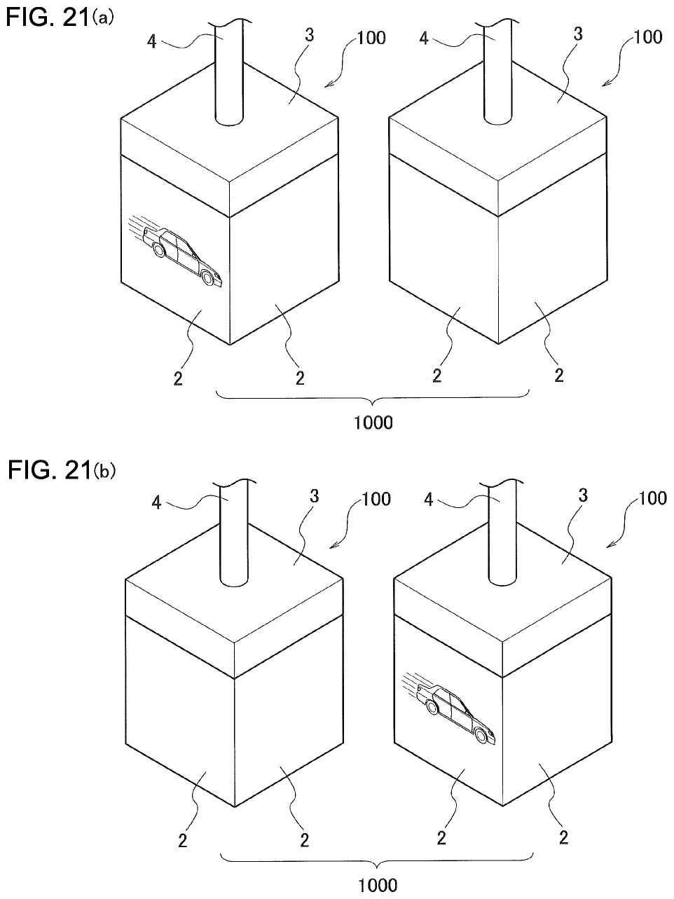

For example, as illustrated in (a) of FIG. 21, one running automobile is displayed on a certain lighting apparatus 100, and nothing is displayed on another lighting apparatus 100. Thereafter, as illustrated in (b) of FIG. 21, that running automobile disappears from the certain lighting apparatus 100, and is displayed on the other lighting apparatus 100. As described above, as display of the integrated predetermined image data, one moving picture may be displayed as a whole by the plurality of lighting apparatuses 100. With this, a rendering from which a flow of time can be read can be executed by the plurality of lighting apparatuses 100.

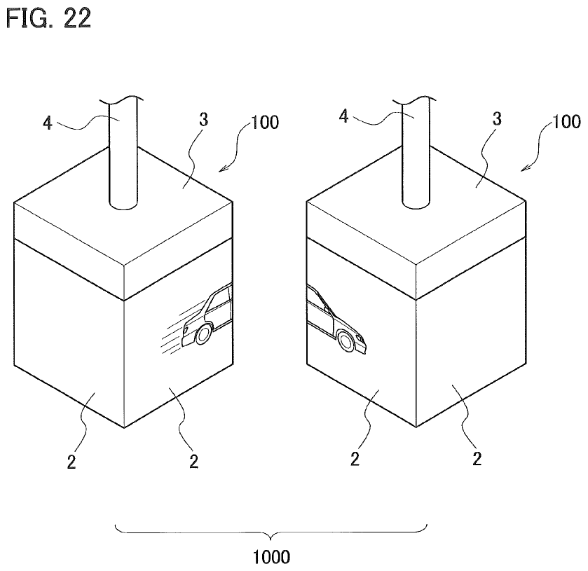

Moreover, in the lighting system 1000 of this embodiment, for example, as illustrated in FIG. 22, one automobile may be divided and displayed by two lighting apparatuses 100. That is, a certain lighting apparatus 100 may display a front portion of one automobile, and another lighting apparatus 100 may display a rear portion of the one automobile. Thus also, interest of the person present around the lighting apparatuses 100 can be attracted.

### Embodiment 12

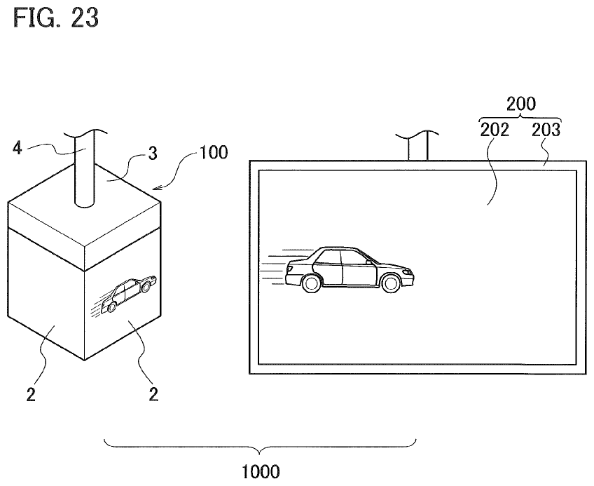

A description will be given below of a lighting system of Embodiment 12 with reference to FIG. 23 to FIG. 25.

A lighting apparatus 100 for use in a lighting system 1000 of this embodiment is the same as the lighting apparatuses 100 of Embodiments 1 to 8, and accordingly, a description of the same portions thereof will not be repeated. Characteristic configurations of the lighting system 1000 of this embodiment will be mainly described.

As illustrated in FIG. 23, the lighting system 1000 of this embodiment includes a lighting apparatus 100 and an external instrument 200. The external instrument 200 is a liquid crystal display electrically connectable to a personal computer and the like. The external instrument 200 includes the lighting apparatus 100 and an external instrument 200 having a display screen 202 and a display controller 203 that controls the display screen 202.

As illustrated in FIG. 23, the controller 3 and the display controller 203 control the electronic panel 2 and the display screen 202, respectively to individually display the same predetermined image data on the electronic panel 2 and the display screen 202 in synchronization with each other. That is, the controller 3 of the lighting apparatus 100 or the display controller 203 of the external instrument 200 in the lighting system 1000 including the lighting apparatus 100 and the external instrument 200 executes a certain program. Simultaneously, the certain lighting apparatus 100 or the external instrument 200 transmits a predetermined signal, and the external instrument 200 or the lighting apparatus 100, which has received the predetermined signal, executes the certain program. Thus, the lighting apparatus 100 and the external instrument 200 display the same predetermined image data at substantially the same time. With this, a great impact can be made on a person who views the predetermined image data around the lighting apparatus 100 and the external instrument 200.

However, a method of such a control may be any as long as the controller 3 and the display controller 203 are synchronized with each other and control the plurality of electronic panels 2 to display the same predetermined image data individually on the plurality of electronic panels 2. For example, a signal to request transmission of the predetermined image data may be transmitted from the communication instrument 30s illustrated in FIG. 3 to the server 30a illustrated therein, and the same predetermined image data may be transmitted from the server 30a to the controller 3 and the display controller 203 in synchronization with each other. Thus, the controller 3 and the display controller 203 may be synchronized with each other and may control the electronic panel 2 and the display screen 202 to display the same predetermined image data in synchronization with each other.

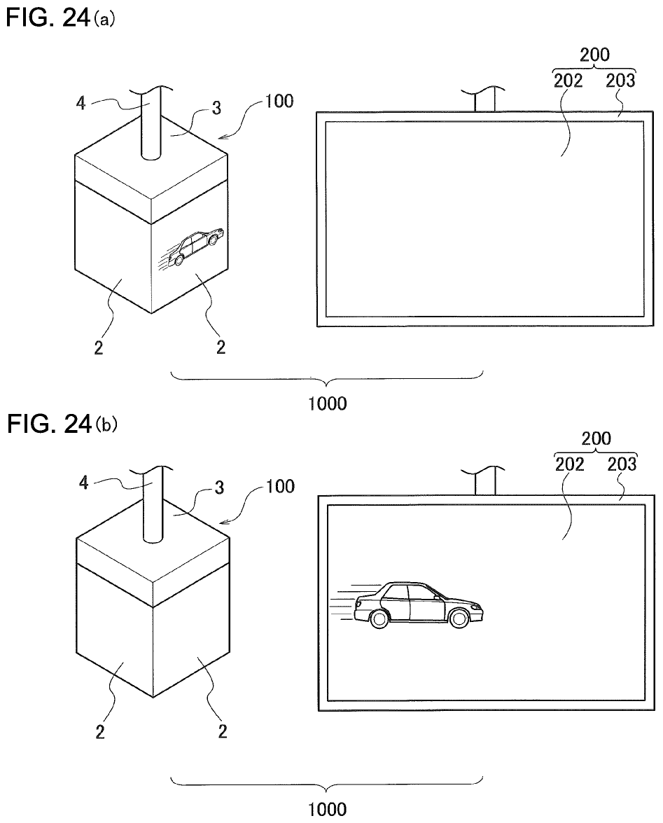

Moreover, for example, as illustrated in (a) of FIG. 24, the controller 3 and the display controller 203 may control the electronic panel 2 and the display screen 202, respectively so that one running automobile is displayed on one lighting apparatus 100. At this time, no automobile is displayed on the external instrument 200. Thereafter, as illustrated in (b) of FIG. 24, the controller 3 and the display controller 203 may control the electronic panel 2 and the display screen 202 so that the one running automobile disappears from the electronic panel 2 of the lighting apparatus 100 and is displayed on the display screen 202 of the external instrument 200. Also, with this, a great impact can be made on the person who views the predetermined image data around the lighting apparatus 100 and the external instrument 200.

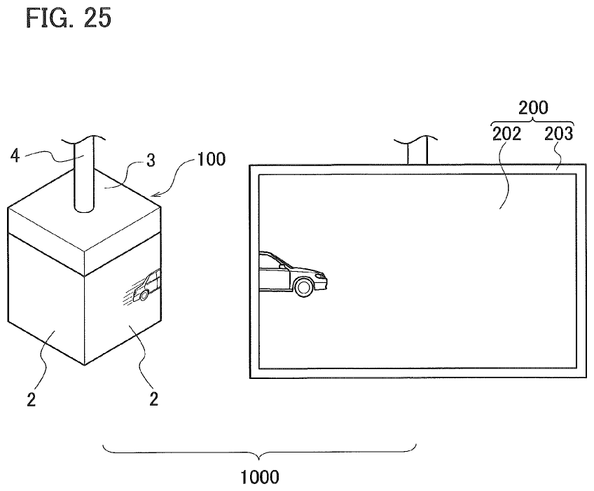

Moreover, as in Embodiment 11, in the lighting system 1000 of this embodiment, as illustrated in FIG. 25, the controller 3 and the display controller 203 may control the electronic panel 2 and the display screen 202 to display predetermined image data integrated as one as a whole on the electronic panel 2 and the display screen 202. Also, with this, a great impact can be made on the person who views the predetermined image data around the lighting apparatus 100 and the external instrument 200.

### (Specific Configuration and Effects Obtained Thereby)

A description will be given below of characteristic configurations of the lighting apparatus 100 and the lighting system 1000 according to each of the embodiments, and of effects obtained thereby.

(1) The lighting apparatus 100 of the embodiment includes: a light source 1 that emits light; an electronic panel 2 that processes and passes therethrough the light emitted by the light source 1; and a controller 3 that controls the electronic panel 2 to display predetermined image data on the electronic panel 2. The controller 3 receives the predetermined image data, which is stored in the external storage device 30 separate from the lighting apparatus 100, from the external storage device 30, and causes such electronic panels 2 to display the received predetermined image data. With this, the predetermined image data stored in the external storage device 30 is changed, whereby variations of the image data to be displayed on the electronic panels 2 of such lighting apparatuses 100 can be enriched.

(2) The external storage device 30 may be a server 30a that is communicably connected to the controller 3 via the electric communication information network I and stores the predetermined image data. In this case, the controller 3 causes the electronic panel 2 to display the predetermined image data transmitted from the server 30a. With this, the electronic panel 2 of the lighting apparatus 100 can be caused to display the predetermined image data selected from among an enormous number of image data stored in the server 30a.

(3) The external storage device 30 may be a recording medium 30b that stores the predetermined image data readable by being attached to the controller 3. In this case, the controller 3 causes the electronic panel 2 to display the predetermined image data read out from the recording medium 30b attached to the controller 3. With this, the electronic panel 2 of the lighting apparatus 100 can be caused to display the predetermined image data by only a simple operation of attaching the recording medium 30b to the controller 3.

(4) The external storage device 30 may be a communication instrument 30s capable of executing a wireless communication. In this case, the controller 3 receives the predetermined image data from the communication instrument 30s, and causes the electronic panel 2 to display the received predetermined image data. With this, the predetermined image data which the electronic panel 2 is caused to display can be easily selected by using the communication instrument 30s.

(5) The predetermined image data may be data to be automatically changed in accordance with a prescribed program. With this, the lighting apparatus 100 and an atmosphere around the same can be automatically changed.

(6) The lighting apparatus 100 may further include a reflector R that reflects the light emitted by the light source 1 or a light-guiding member G that guides the light emitted by the light source 1. In this case, the light reflected by the reflector R or the light guided by the light-guiding member G passes through the electronic panel 2. With this, variations of a design of the lighting apparatus 100 can be enriched.

(7) The light source 1 may be one capable of executing at least one of dimming and toning. In this case, the controller 3 controls the light source 1 to execute at least one of dimming and toning of the light emitted from the light source 1 while controlling the electronic panel 2. With this, the variations of the predetermined image data can be further enriched by combining the control of the electronic panel 2 and the control of the light source 1 with each other.

(8) The lighting apparatus 100 may further include an imager C that acquires image data around the lighting apparatus 100. The controller 3 may control the electronic panel 2 to display the predetermined image data on the electronic panel 2 in response to the image data around the lighting apparatus 100, which is acquired by the imager C. With this, the controller 3 can cause the electronic panel 2 to display the predetermined image data corresponding to a situation around the lighting apparatus 100.

(9) The controller 3 may include a specifier 3S that specifies an object or a display, which is present on an extension of a line of sight of a person H present around the lighting apparatus 100, based on the image data around the lighting apparatus 100, the image data being acquired by the imager C. The controller 3 may include a storage 3M that stores data of the object or the display, which is present on the extension of the line of sight of the person H. The controller 3 may include an estimator 3C that estimates a preference of the person present around the lighting apparatus 100 based on the data of the object or the display, which is present on the extension of the line of sight of the person H. The controller 3 may generate, as the predetermined image data, information suitable for the preference of the person H present around the lighting apparatus 100, the preference being estimated by the estimator 3C, and control the electronic panel 2 to display the generated predetermined image data on the electronic panel 2. With this, the electronic panel 2 can be caused to display information useful for the person H present around the lighting apparatus 100.

(10) The lighting apparatus 100 may further include an imager C that acquires image data around the lighting apparatus 100. The controller 3 may transmit the image data around the lighting apparatus 100, the image data being imaged by the imager C, may receive the predetermined image data selected based on the image data around the lighting apparatus 100, and may cause the electronic panel 2 to display the received predetermined image data. Thus also, the electronic panel 2 can be caused to display information useful for the person H present around the lighting apparatus 100.

(11) The lighting apparatus 100 may further include a sound information acquisitor S that acquires sound information generated around the lighting apparatus 100. In this case, the controller 3 may control the electronic panel 2 to display predetermined image data on the electronic panel 2 in response to the sound information acquired by the sound information acquisitor S. Thus also, the controller 3 can cause the electronic panel 2 to display the predetermined image data corresponding to the situation of the sound generated around the lighting apparatus 100.

(12) The lighting apparatus 100 may include a sound information acquisitor S that acquires sound information generated around the lighting apparatus 100. The controller 3 may transmit the sound information acquired by the sound information acquisitor S, may receive the predetermined image data selected based on the sound information, and may cause the electronic panel 2 to display the received predetermined image data. Thus also, the controller 3 can cause the electronic panel 2 to display the predetermined image data corresponding to the situation of the sound generated around the lighting apparatus 100.

(13) As the external storage device 30, a database DB may be provided, the database DB including a data table DT that stores the at least one of the predetermined image data to be displayed on the display panel 2 and at least one light signal emitted by the light source 1 in a one-to-one association relationship. At a time of causing the display panel 2 to display any one specific piece of image data among the at least one of the predetermined image data, the controller 3 may cause the light source 1 to transmit a specific light signal corresponding to the specific image data selected from the at least one light signal. With this, the controller 3 can cause the communication instrument 30s, which has received the light signal, to display image data related to the predetermined image data displayed on the display panel 2.

(14) As the external storage device 30, a database DB may be provided for each of a plurality of types of categories, the database DB including a data table DT that stores the predetermined image data to be displayed on the display panel 2 and a light emitting mode of the light emitted by the light source 1 in association with each other. In some cases, one specific category among the plurality of types of categories is designated. In this case, at the time of causing the display panel 2 to display predetermined image data belonging to the specific category, the controller 3 causes the light source 1 to emit light in a light emitting mode belonging to the specific category. With this, by just designating the category by the external communication instrument 3s, a rendering in which the predetermined image data of the display panel 2 and the light emitting mode of the light source 1 are associated with each other can be executed.

(15) The lighting system 1000 includes a plurality of the lighting apparatuses 100. A plurality of the controllers 3 control a plurality of the electronic panels 2 to display the same predetermined image data individually on the plurality of electronic panels 2 in synchronization with each other. Alternatively, the plurality of controllers 3 may control the plurality of electronic panels 2 to display predetermined image data integrated as one as a whole on the plurality of electronic panels 2. With this, a great impact can be made on a person who views the predetermined image data around the plurality of lighting apparatuses 100.

(16) The lighting system 1000 includes the lighting apparatus 100 and an external instrument 200 including a display screen 202 and a display controller 203 that controls the display screen 202. The controller 3 and the display controller 203 control the electronic panel 2 and the display screen 202, respectively to individually display the same predetermined image data on the electronic panel 2 and the display screen 202 in synchronization with each other. Alternatively, the controller 3 and the display controller 203 control the electronic panel 2 and the display screen 202, respectively to display the predetermined image data, which is integrated as one as a whole, on the electronic panel 2 and the display screen 202. With this, a great impact can be made on a person who views the predetermined image data around the lighting apparatus 100 and the external instrument 200.

### REFERENCE SIGNS LIST

1 Light source

2 Electronic panel

3 Controller

3M Storage

3S Specifier

3T Timer

3C Estimator

30 External storage device

30a Server

30b Recording medium

30s Communication instrument

100 Lighting apparatus

202 Display screen

203 Display controller

1000 Lighting system

C Imager

G Light-guiding member

I Electric communication information network

R Reflector

S Sound information acquisitor

1. A lighting apparatus comprising:
a light source configured to emit light;
an electronic panel configured to process and pass therethrough the light emitted by the light source; and
a controller configured to control the electronic panel to display predetermined image data on the electronic panel,
wherein the controller receives the predetermined image data, which is stored in an external storage device separate from the lighting apparatus, from the external storage device, and causes the electronic panel to display the received predetermined image data.

2. The lighting apparatus according to claim 1, wherein the external storage device is a server that is communicably connected to the controller via an electric communication information network and stores the predetermined image data, and
wherein the controller causes the electronic panel to display the predetermined image data transmitted from the server.

3. The lighting apparatus according to claim 1, wherein the external storage device is a recording medium that stores the predetermined image data readable by being attached to the controller, and
wherein the controller causes the electronic panel to display the predetermined image data read out from the recording medium attached to the controller.

4. The lighting apparatus according to claim 1, wherein the external storage device is a communication instrument capable of executing a wireless communication, and
wherein the controller receives the predetermined image data from the communication instrument, and causes the electronic panel to display the received predetermined image data.

5. The lighting apparatus according to claim 1, wherein the predetermined image data is data to be automatically changed in accordance with a prescribed program.

6. The lighting apparatus according to claim 1, further comprising: a reflector configured to reflect the light emitted by the light source or a light-guiding member configured to guide the light emitted by the light source,
wherein the light reflected by the reflector or the light guided by the light-guiding member passes through the electronic panel.

7. The lighting apparatus according to claim 1, wherein the light source is one capable of executing at least one of dimming and toning, and
wherein the controller controls the light source to execute the at least one of the dimming and toning of the light emitted by the light source while controlling the electronic panel.

8. The lighting apparatus according to claim 1, further comprising: an imager configured to acquire image data around the lighting apparatus,
wherein the controller controls the electronic panel to display the predetermined image data on the electronic panel in response to the image data around the lighting apparatus, the image data being acquired by the imager.

9. The lighting apparatus according to claim 8, wherein the controller further comprises:
a specifier configured to specify an object or a display, which is present on an extension of a line of sight of a person present around the lighting apparatus, based on the image data around the lighting apparatus, the image data being acquired by the imager;
a storage configured to store data of the object or the display, which is present on the extension of the line of sight of the person and specified by the specifier; and
an estimator configured to estimate a preference of the person present around the lighting apparatus based on the data of the object or the display, which is present on the extension of the line of sight of the person, the data being stored in the storage, and
wherein the controller generates, as the predetermined image data, information suitable for the preference of the person present around the lighting apparatus, the preference being estimated by the estimator, and controls the electronic panel to display the generated predetermined image data on the electronic panel.

10. The lighting apparatus according to claim 1, further comprising: an imager configured to acquire image data around the lighting apparatus,
wherein the controller transmits the image data around the lighting apparatus, the image data being imaged by the imager, receives the predetermined image data selected based on the image data around the lighting apparatus, and causes the electronic panel to display the received predetermined image data.

11. The lighting apparatus according to claim 1, further comprising: a sound information acquisitor configured to acquire sound information generated around the lighting apparatus,
wherein the controller controls the electronic panel to display the predetermined image data on the electronic panel in response to the sound information acquired by the sound information acquisitor.

12. The lighting apparatus according to claim 1, further comprising: a sound information acquisitor configured to acquire sound information generated around the lighting apparatus,
wherein the controller transmits the sound information acquired by the sound information acquisitor, receives the predetermined image data selected based on the sound information, and causes the electronic panel to display the received predetermined image data.

13. The lighting apparatus according to claim 1, wherein, as the external storage device, a database is provided, the database comprising a data table that stores at least one of the predetermined image data to be displayed on the display panel and at least one light signal emitted by the light source in a one-to-one association relationship, and
wherein, at a time of causing the display panel to display any one specific piece of image data among the at least one of the predetermined image data, the controller causes the light source to transmit a specific light signal corresponding to the specific image data selected from the at least one light signal.

14. The lighting apparatus according to claim 1, wherein, as the external storage device, a database is provided for each of a plurality of types of categories, the database comprising a data table that stores the predetermined image data to be displayed on the display panel and a light emitting mode of the light emitted by the light source in association with each other, and
wherein, when any one specific category among the plurality of types of categories is designated, the controller causes the light source to emit light in the light emitting mode belonging to the specific category when the display panel is caused to display the predetermined image data belonging to the specific category.

15. A lighting system comprising:
a plurality of lighting apparatuses, each including a same configuration as a configuration of the lighting apparatus according to claim 1,
wherein a plurality of the controllers control a plurality of the electronic panels to display the same predetermined image data individually on the plurality of electronic panels in synchronization with each other, or control the plurality of electronic panels to display the predetermined image data integrated as one as a whole on the plurality of electronic panels.

16. A lighting system comprising:
the lighting apparatuses, each being according to claim 1; and
an external instrument comprising: a display screen; and a display controller configured to control the display screen,
wherein the controller and the display controller control the electronic panel and the display screen, respectively to individually display the same predetermined image data on the electronic panel and the display screen in synchronization with each other, or control the electronic panel and the display screen to display the predetermined image data integrated as one as a whole on the electronic panel and the display screen.
